(19) United States
(12) Patent Application Publication
(10) Pub. No.: US 2026/0243027 A1
(43) Pub. Date: Aug. 20, 2026

(54) MULTILAYER STRUCTURE, ROLL-SHAPED STRUCTURE, AND PACKAGING MATERIAL

(71) Applicant: Kuraray Co., Ltd., Okayama (JP)

(72) Inventors: Keisuke MORIKAWA, Kurashiki-shi, Okayama (JP); Yuta TAOKA, Houston, TX (US)

(73) Assignee: Kuraray Co., Ltd., Okayama (JP)

(21) Appl. No.: 19/161,597

(22) PCT Filed: Feb. 27, 2024
(86) PCT No.: PCT/JP2024/007105

§ 371 Date: Sep. 2, 2025

(30) Foreign Application Priority Data
Mar. 1, 2023 (JP) 2023-031235

(51) Int. Cl. D21H 19/84; B32B 27/20; B32B 29/00; D21H 19/22; D21H 27/30

(52) U.S. Cl. CPC D21H 19/84; B32B 27/20; B32B 29/00; D21H 19/22; D21H 27/30; B32B 2553/00

(57) ABSTRACT

The present disclosure provides a multilayer structure and a rolled structure; and a packaging material including such a multilayer structure. The multilayer structure includes: a paper base material; a layer A laminated to one face side of the paper base material; and a layer B laminated to another face side of the paper base material.

### TECHNICAL FIELD

The present invention relates to a multilayer structure, a rolled structure, and a packaging material.

### BACKGROUND ART

In the packaging of foods and the like, a packaging material including a paper base material to which a water vapor barrier property, gas barrier properties, oil resistance, and the like are imparted has been conventionally used. Patent Document 1 discloses a packaging material in which a water vapor barrier layer, a gas barrier layer, and a heat-sealing layer are laminated in this order to at least one face of a paper base material.

### PRIOR ART DOCUMENT

### Patent Document

Patent Document 1: Japanese Unexamined Patent Application, Publication No. 2021-20398

### SUMMARY OF THE INVENTION

### Problems to be Solved by the Invention

Various printing is typically applied to surfaces of packaging materials for foods and the like. Accordingly, a pigment layer may be provided on at least one face of a paper base material, for the purpose of, for example, improving printability, appearance, and smoothness.

In a case in which one or a plurality of resin layers are provided by coating or the like on one face of a paper base material having the other face on which a pigment layer is provided, a long multilayer structure in production process may be rolled into a roll after each resin layer is provided. Furthermore, a finished long multilayer structure is also typically, for example, stored in a rolled state. When the unfinished or finished multilayer structure is in such a rolled state, defects may occur on a surface of the resin layer. The defects on a surface of the resin layer may not only cause poor appearance, but may also deteriorate, for example, various desired barrier properties. Regarding the occurrence of such defects on a surface of the resin layer, the inventors have found that: a main cause is that when the pigment layer and the resin layer are in contact, blocking occurs between these two layers, causing the pigment on a surface of the pigment layer to adhere to the resin layer; and that the pigment adhesion occurs significantly in a case of the resin layer containing a polymer having a low glass transition temperature, such as a heat-sealing layer.

An object of the present invention is to provide: a multilayer structure and a rolled structure that inhibit adhesion of a pigment to a resin layer and have favorable barrier properties; and a packaging material including such a multilayer structure.

### Means for Solving the Problems

The above-described object is achieved by providing any one of the following:
(1) A multilayer structure including: a paper base material; a layer A laminated to one face side of the paper base material; and a layer B laminated to another face side of the paper base material, wherein the layer A contains a pigment; the layer B contains a polymer (a) having a glass transition temperature of 25° C. or less, and a polymer (b) having a glass transition temperature of 30° C. or more; and a content of the polymer (b) with respect to 100 parts by mass of the polymer (a) is 1 part by mass or more and 50 parts by mass or less;
(2) The multilayer structure according to (1), wherein the polymer (a) and the polymer (b) are each water-soluble or water-dispersible;
(3) The multilayer structure according to (1) or (2), wherein a total content of the polymer (a) and the polymer (b) in the layer B is 20% by mass or more and 100% by mass or less;
(4) The multilayer structure according to any one of (1) to (3), wherein the polymer (b) is a vinyl alcohol polymer;
(5) The multilayer structure according to (4), wherein the vinyl alcohol polymer has a degree of saponification of 80 mol % or more and 100 mol % or less;
(6) The multilayer structure according to (4), wherein the vinyl alcohol polymer has a degree of saponification of more than 96 mol % and 100 mol % or less;
(7) The multilayer structure according to any one of (4) to (6), wherein the vinyl alcohol polymer has a viscosity-average degree of polymerization of 200 or more and 3,000 or less;
(8) The multilayer structure according to any one of (1) to (7), wherein the polymer (a) contains at least one selected from the group consisting of a styrene polymer, a modified olefin polymer, and an ester polymer;
(9) The multilayer structure according to any one of (1) to (8), including the layer A, the paper base material, a pre-coat layer, a barrier layer, and a heat-sealing layer in this order, wherein the pre-coat layer is the layer B;
(10) The multilayer structure according to any one of (1) to (8), including the layer A, the paper base material, a pre-coat layer, a barrier layer, and a heat-sealing layer in this order, wherein the heat-sealing layer is the layer B;
(11) The multilayer structure according to any one of (1) to (8), including the layer A, the paper base material, a pre-coat layer, a barrier layer, and a heat-sealing layer in this order, wherein the pre-coat layer and the heat-sealing layer are the layer B;
(12) The multilayer structure according to any one of (9) to (11), wherein the barrier layer contains a vinyl alcohol polymer;
(13) A rolled structure formed by rolling the multilayer structure according to any one of (1) to (8) and (10) to (12), wherein the layer A and the layer B are in direct contact; and
(14) A packaging material including the multilayer structure according to any one of (1) to (12).

### Effects of the Invention

The present invention can provide: a multilayer structure and a rolled structure that inhibit adhesion of a pigment to a resin layer and have favorable barrier properties; and a packaging material including such a multilayer structure.

### BRIEF DESCRIPTION OF THE DRAWING

FIG. 1 is a schematic cross-sectional view illustrating a multilayer structure according to one embodiment of the present invention.

### DESCRIPTION OF EMBODIMENTS

### Multilayer Structure

A multilayer structure according to one embodiment of the present invention includes: a paper base material; a layer A laminated to one face side of the paper base material; and a layer B laminated to another face side of the paper base material, wherein the layer A contains a pigment; the layer B contains a polymer (a) having a glass transition temperature of 25° C. or less, and a polymer (b) having a glass transition temperature of 30° C. or more; and a content of the polymer (b) with respect to 100 parts by mass of the polymer (a) is 1 part by mass or more and 50 parts by mass or less.

The multilayer structure, in which adhesion of the pigment to the resin layer (i.e., the layer B) is inhibited, has favorable barrier properties. The reason for the multilayer structure achieving such an effect is not necessarily clarified, but the reason as described below is presumed. Due to the layer B to serve as a resin layer containing a predetermined amount of the polymer (b) having a glass transition temperature of 30° C. or more, together with the polymer (a) having a glass transition temperature of 25° C. or less, the adhesiveness of a surface of the layer B to the pigment at or near room temperature decreases. As a result, even in the case in which the multilayer structure that is unfinished or finished is rolled such that the layer A and the layer B are in direct contact, blocking between the layer A and the layer B is inhibited, and adhesion of the pigment to the layer B is inhibited. In the case in which adhesion of the pigment to the layer B is inhibited, roughness of the surface of the layer B due to the pigment, or the like is also inhibited, and thus favorable barrier properties due to the layer B and the like are exhibited. On the other hand, in a case in which the content of the polymer (b) with respect to the polymer (a) in the layer B is too large, the barrier properties due to the polymer (a) to be originally exhibited may be inhibited by the polymer (b). The multilayer structure including the layer B in which the content of the polymer (b) with respect to 100 parts by mass of the polymer (a) is 1 part by mass or more and 50 parts by mass or less can inhibit roughness of the surface of the layer B, and can sufficiently achieve effects of the polymer (a) and thus exhibit sufficient barrier properties due to the layer B and the like.

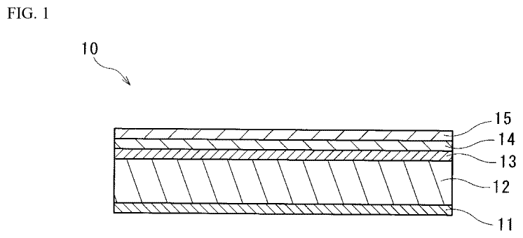

A multilayer structure 10 according to one embodiment of the present invention illustrated in FIG. 1 includes a layer A 11, a paper base material 12, a pre-coat layer 13, a barrier layer 14, and a heat-sealing layer 15 in this order. In the multilayer structure 10 of the present embodiment, at least one of the pre-coat layer 13 and the heat-sealing layer 15 is the above-described layer B. Both the pre-coat layer 13 and the heat-sealing layer 15 may be the above-described layer B. The pre-coat layer 13 and the heat-sealing layer 15 may be layers having the same composition, or may be layers having different compositions.

The multilayer structure 10 of the embodiment in FIG. 1 is a five-layer structure consisting of only the layer A 11, the paper base material 12, the pre-coat layer 13, the barrier layer 14, and the heat-sealing layer 15. In another embodiment, the multilayer structure may further include another layer. For example, a resin layer referred to as an overcoat layer or the like may be provided between the barrier layer 14 and the heat-sealing layer 15. A pigment layer or the like may be provided between the paper base material 12 and the pre-coat layer 13. A multilayer structure according to one embodiment may have a three-layer structure including the layer A, the paper base material, and the layer B. For example, in the case of the multilayer structure 10 in FIG. 1 including the pre-coat layer 13 that is the layer B, a multilayer structure consisting of three layers including the layer A 11, the paper base material 12, and the pre-coat layer 13 in production process of the multilayer structure 10 is also one embodiment of the present invention. In addition, a multilayer structure of the present invention may include three or more layers B, and may include, for example, a metal layer or the like.

In a multilayer structure according to one embodiment of the present invention, the layer A and the layer B may each be an outermost layer with one face exposed. However, for example, another layer may be further laminated to or printing may be applied to a part of the surface (exposed face) of the layer A serving as an outermost layer. Similarly, another layer may be further laminated to or printing may be applied to a part of the surface (exposed face) of the layer B serving as an outermost layer. Each layer and the like of the multilayer structure will be described in detail below.

### Paper Base Material

As the paper base material, general paper containing a plant-based pulp as a principal component may be used. It is to be noted that the “principal component” as referred to herein means a component having the highest content on mass basis. The paper base material may contain, besides the pulp, a sizing agent, a filler, a paper-strengthening agent, a yield-improving agent, a pH-adjusting agent, a drainage-improving agent, a water-proofing agent, a softener, an antistatic agent, a defoaming agent, a slime-controlling agent, a dye, a pigment, and/or the like. The paper base material is exemplified by kraft paper, woodfree paper, mechanical paper, alkaline paper, a paperboard, glassine paper, semi-glassine paper, parchment paper, and the like.

A basis weight (mass per unit area) of the paper base material is not particularly limited, and is preferably 20 g/m² or more and 500 g/m² or less, more preferably 30 g/m² or more and 300 g/m² or less, and still more preferably 40 g/m² or more and 200 g/m² or less.

A density of the paper base material is preferably 0.5 g/cm³ or more and 1.2 g/cm³ or less, and more preferably 0.6 g/cm³ or more and 1.0 g/cm³ or less.

The paper base material can be produced by a well-known method. Furthermore, a commercial product may be used as the paper base material.

### Layer A

The layer A is a layer laminated to one face side of the paper base material. The layer A may be laminated directly to the paper base material, or may be laminated to the paper base material via another layer.

The layer A contains a pigment. The pigment is not particularly limited, and, for example, any well-known pigment used in coated paper can be used. The pigment may be an organic pigment or an inorganic pigment, and is preferably an inorganic pigment. The pigment is exemplified by soft calcium carbonate, heavy calcium carbonate, kaolin, calcined kaolin, engineered kaolin, clay, talc, silica, colloidal silica, calcium sulfate, barium sulfate, titanium dioxide, zinc oxide, zinc sulfide, zinc carbonate, satin white, aluminum silicate, calcium silicate, magnesium silicate, aluminum hydroxide, alumina, magnesium carbonate, magnesium hydroxide, kaolinite, antigorite, smectite, vermiculite, mica, and the like. Of these, clay is preferred. One type or two or more types of the pigment may be used.

A content of the pigment in the layer A is preferably 60% by mass or more and 99% by mass or less, and more preferably 70% by mass or more and 95% by mass or less, and may be 75% by mass or more and 90% by mass or less.

The layer A typically contains a binder together with the pigment. As the binder, for example, a well-known binder used in coated paper can be used. The binder is exemplified by vinyl alcohol polymers, acrylic polymers, cellulose derivatives, starches, styrene polymers, ester polymers, olefin polymers, fluororesins, silicone resins, polyvinyl chloride, polyvinyl acetate, polyacrylamides, polyacrylic acid esters, polyvinyl butyrals, polystyrose, polyamides, and the like. One type or two or more types of the binder may be used.

A content of the binder in the layer A is preferably 1% by mass or more and 40% by mass or less, and more preferably 5% by mass or more and 30% by mass or less, and may be 10% by mass or more and 25% by mass or less. A total content of the pigment and the binder in the layer A is preferably 80% by mass or more and 100% by mass or less, and may be 90% by mass or more and 100% by mass or less.

The layer A may further contain other component(s) aside from the pigment and the binder, such as a dispersant, a viscosity improver, a water retention agent, a defoaming agent, a water-proofing agent, a fluorescent dye, a coloring dye, a surfactant, a pH-adjusting agent, an ultraviolet ray-absorbing agent, a metal salt, and/or the like.

### Layer B

The layer B is a layer laminated to the face side of the paper base material opposite to the side to which the layer A is laminated. The layer B may be laminated directly to the paper base material, or may be laminated to the paper base material via another layer. As described above, the layer B may be, for example, the pre-coat layer disposed between the paper base material and the barrier layer, or may be the heat-sealing layer. The layer B may include only one layer or two or more layers.

The layer B contains the polymer (a) having a glass transition temperature of 25° C. or less, and the polymer (b) having a glass transition temperature of 30° C. or more. In a case in which the polymer (a) is composed of two or more types of polymers, the glass transition temperature of each polymer is 25° C. or less. Similarly, in a case in which the polymer (b) is composed of two or more types of polymers, the glass transition temperature of each polymer is 30° C. or more. In other words, all polymers contained in the layer B are classified into the polymer (a) having a glass transition temperature of 25° C. or less, the polymer (b) having a glass transition temperature of 30° C. or more, or a polymer having a glass transition temperature of more than 25° C. and less than 30° C. It is to be noted that the polymer having a glass transition temperature of more than 25° C. and less than 30° C. is an optional component. The glass transition temperature of the polymer is measured by differential scanning calorimetry (DSC). Specifically, the glass transition temperature can be measured by a method described in EXAMPLES.

### Polymer (a)

The upper limit of the glass transition temperature of the polymer (a) is 25° C., preferably 20° C., more preferably 15° C., still more preferably 10° C., and even more preferably 5° C. Due to the glass transition temperature of the polymer (a) being equal to or less than the upper limit, the layer B can exhibit favorable bending resistance, interlayer adhesiveness, and the like. Furthermore, in the case in which the layer B is a heat-sealing layer, favorable heat-sealing properties can be also exhibited. The lower limit of the glass transition temperature of the polymer (a) is not particularly limited, and may be, for example, −150° C., −100° C., −50° C., or −15° C.

Although the polymer (a) is not particularly limited as long as it is a polymer having a glass transition temperature of 25° C. or less, the polymer (a) preferably contains at least one selected from the group consisting of a styrene polymer, a modified olefin polymer, and an ester polymer, and more preferably is at least one selected from the group consisting of a styrene polymer, a modified olefin polymer, and an ester polymer. When such a polymer is used as the polymer (a), the layer B can exhibit a favorable water vapor barrier property and the like. One type or two or more types of the polymer (a) may be used.

### Styrene Polymer

The styrene polymer is a polymer containing a styrene compound as a monomer. The styrene compound as referred to herein means styrene and a compound obtained by substituting a hydrogen atom included in styrene, with another atom or another group. Examples of the styrene compound include styrene, α-methylstyrene, vinyltoluene, chlorostyrene, and the like, and styrene is preferred.

The styrene polymer is exemplified by polystyrenes, styrene-acrylic copolymers, styrene-butadiene-based copolymers, and the like.

The styrene-acrylic copolymer is a copolymer of the above-described styrene compound and an acrylic compound. The acrylic compound as referred to herein means a (meth)acrylic acid and a compound obtained by substituting a hydrogen atom of a carboxy group constituting a (meth)acrylic acid, with another atom or another group. The acrylic compound is exemplified by (meth)acrylic acids, (meth)acrylic acid esters, (meth)acrylic acid salts, and the like. Examples of the (meth)acrylic acid esters include (meth)acrylic acid alkyl esters such as methyl (meth)acrylate and ethyl (meth)acrylate. Examples of the (meth)acrylic acid salts include sodium (meth)acrylate, and the like. It is to be noted that the “(meth)acrylic acid” as referred to herein means acrylic acid and methacrylic acid.

Examples of the styrene-acrylic copolymers include styrene-(meth)acrylic acid copolymers, styrene-(meth)acrylic acid ester copolymers, styrene-(meth)acrylic acid salt copolymers, and the like. The styrene-acrylic copolymer may be further copolymerized with another monomer.

The styrene-butadiene-based copolymer is a copolymer of the above-described styrene compound and a butadiene compound. The butadiene compound as referred to herein means butadiene and a compound obtained by substituting a hydrogen atom included in butadiene, with another atom or another group. Examples of the butadiene compound include 1,3-butadiene, 2-methyl-1,3-butadiene (i.e., isoprene), 2,3-dimethyl-1,3-butadiene, 1,3-pentadiene, and the like, and 1,3-butadiene is preferred.

As the styrene-butadiene-based copolymer, a styrene-butadiene copolymer is preferred. The styrene-butadiene-based copolymer may be further copolymerized with another monomer.

As the styrene polymer, the styrene-butadiene-based copolymer is preferred.

### Modified Olefin Polymer

The modified olefin polymer is a polymer containing, as monomers, an olefin and other monomer aside from olefins. The modified olefin polymer may be a copolymer of an olefin and other monomer, or may be a polyolefin post-modified with other monomer. The modified olefin polymer is preferably a copolymer of an olefin and other monomer.

Examples of the olefin include α-olefins such as ethylene, propylene, n-butene, and isobutylene, and ethylene is preferred.

The other monomer aside from the olefin constituting the modified olefin polymer is exemplified by unsaturated carboxylic acid compounds, diene compounds, vinyl esters, vinyl ethers, vinyl halides, vinylidene halides, allyl compounds, and the like, and the unsaturated carboxylic acid compounds or the vinyl esters are preferred, and the unsaturated carboxylic acid compounds are more preferred.

The unsaturated carboxylic acid compound as referred to herein means an unsaturated carboxylic acid and a compound obtained by substituting a hydrogen atom of a carboxy group constituting an unsaturated carboxylic acid, with another atom or another group. In other words, the unsaturated carboxylic acid compound is exemplified by unsaturated carboxylic acid esters, unsaturated carboxylic acid salts, unsaturated carboxylic acid anhydrides, and the like, besides unsaturated carboxylic acids. The unsaturated carboxylic acid compound is preferably a monomer having a carboxy group or a salt thereof.

Examples of the unsaturated carboxylic acid compound include: unsaturated carboxylic acids such as (meth)acrylic acid, crotonic acid, cinnamic acid, itaconic acid, fumaric acid, maleic acid, and butene tricarboxylic acid; unsaturated carboxylic acid esters such as methyl (meth)acrylate, ethyl (meth)acrylate, itaconic acid monoethyl ester, and fumaric acid monobutyl ester; unsaturated carboxylic acid salts such as sodium (meth)acrylate; unsaturated carboxylic acid anhydrides such as maleic anhydride; and the like.

Examples of the vinyl esters include vinyl acetate, vinyl formate, vinyl propionate, vinyl valerate, vinyl caprate, vinyl laurate, vinyl stearate, vinyl pivalate, vinyl versatate, and the like; and vinyl acetate is preferred.

The modified olefin polymer is preferably an olefin-unsaturated carboxylic acid copolymer or an olefin-vinyl ester copolymer, and more preferably an olefin-unsaturated carboxylic acid copolymer. The olefin-unsaturated carboxylic acid copolymer as referred to herein means a copolymer of one type or two or more types of olefins and one type or two or more types of unsaturated carboxylic acid compounds. The olefin-vinyl ester copolymer as referred to herein means a copolymer of one type or two or more types of olefins and one type or two or more types of vinyl esters. The olefin-unsaturated carboxylic acid copolymer may be also referred to as a carboxylic acid-modified polyolefin. The carboxylic acid-modified polyolefin may be a polyolefin containing a carboxy group introduced therein. As the modified olefin polymer, a saponified product of an olefin-vinyl ester copolymer may be used.

The olefin-unsaturated carboxylic acid copolymer is preferably a copolymer of ethylene and the unsaturated carboxylic acid compound, and more preferably a copolymer of ethylene and the unsaturated carboxylic acid or a copolymer of ethylene and the unsaturated carboxylic acid anhydride. The copolymer of ethylene and the unsaturated carboxylic acid, and the copolymer of ethylene and the unsaturated carboxylic acid anhydride may be referred to as a carboxylic acid-modified polyethylene. The carboxylic acid-modified polyethylene may be a polyethylene containing a carboxy group introduced therein.

The olefin-vinyl ester copolymer is preferably an ethylene-vinyl acetate copolymer.

A content percentage of an olefin unit with respect to total monomer units in the modified olefin polymer may be 10 mol % or more and 99 mol % or less, and may be 30 mol % or more and 95 mol % or less.

### Ester Polymer

The ester polymer is a polymer obtained by polymerizing one type or two or more types of monomers through ester bonds. Examples of the ester polymer include polyethylene terephthalate, polybutylene terephthalate, polytrimethylene terephthalate, polyethylene naphthalate, polyglycolic acid, aromatic liquid crystalline polyester, and the like. Furthermore, the ester polymer may be a biodegradable ester polymer. Examples of the biodegradable ester polymers include polyethylene succinate, polybutylene succinate, polybutylene succinate adipate, polybutylene succinate lactate, polybutylene adipate terephthalate, poly 3-hydroxybutanoic acid, poly 3-hydroxybutanoic acid-3-hydroxyhexanoic acid, and the like.

As the polymer (a), the styrene polymer or the modified olefin polymer is preferred, the styrene polymer is more preferred, the styrene-butadiene-based copolymer is still more preferred, and the styrene-butadiene copolymer is particularly preferred, in light of the water vapor barrier property, the blocking resistance, and the like.

The polymer (a) is preferably a polymer that is water soluble or water dispersible. In such a case, the layer B can be efficiently formed by using a coating liquid containing water as a solvent or a dispersion medium. The polymer that is water soluble or water dispersible is exemplified by styrene-acrylic copolymers, styrene-butadiene-based copolymers, olefin-unsaturated carboxylic acid copolymers, olefin-vinyl ester copolymers, and the like. In addition, well-known water-soluble or water-dispersible polymers commercially available can also be used.

The lower limit of a content of the polymer (a) in the layer B is preferably 20% by mass, more preferably 40% by mass, still more preferably 60% by mass, and even more preferably 65% by mass, and may be 70% by mass, 75% by mass, or 80% by mass. Due to the content of the polymer (a) being equal to or more than the lower limit, it is possible to improve the barrier properties (for example, the water vapor barrier property), the bending resistance, and the like. Furthermore, in the case in which the layer B is a heat-sealing layer, the heat-sealing properties can also be improved. On the other hand, the upper limit of the content is preferably 99% by mass, more preferably 95% by mass, still more preferably 92% by mass, and even more preferably 85% by mass.

### Polymer (b)

The lower limit of the glass transition temperature of the polymer (b) is 30° C., preferably 40° C., more preferably 50° C., and still more preferably 60° C. Due to the glass transition temperature of the polymer (b) being equal to or more than the lower limit, the adhesiveness of the layer B to the layer A in a typical temperature environment decreases, and blocking between the layer A and the layer B is inhibited, so that adhesion of the pigment to the layer B is inhibited. The upper limit of the glass transition temperature of the polymer (b) is not particularly limited, and may be, for example, 200° C., 150° C., or 100° C.

The polymer (b) is preferably a polymer that is water soluble or water dispersible, and more preferably a polymer that is water soluble. In particular, it is preferred that the polymer (a) and the polymer (b) are each a polymer that is water soluble or water dispersible. In such a case, the layer B can be efficiently formed by using a coating liquid containing water as a solvent or a dispersion medium. The polymer (b) that is water soluble is exemplified by vinyl alcohol polymers, starches, and the like.

Although the polymer (b) is not particularly limited as long as it is a polymer having a glass transition temperature of 30° C. or more, the polymer (b) is preferably a polymer that is water soluble or water dispersible, and more preferably a vinyl alcohol polymer, as described above. Use of a vinyl alcohol polymer as the polymer (b) results in advantages of: improving film-forming properties; imparting toughness; and the like. One type or two or more types of the polymer (b) may be used.

### Vinyl Alcohol Polymer

The vinyl alcohol polymer is a polymer having a vinyl alcohol unit (—CH₂—CHOH—). The vinyl alcohol polymer is typically obtained by saponifying a vinyl ester polymer. A vinyl ester constituting the vinyl ester polymer is exemplified by the various types of vinyl esters exemplified above as the other monomer aside from the olefin constituting the modified olefin polymer, and vinyl acetate is preferred.

The lower limit of a degree of saponification of the vinyl alcohol polymer may be, for example, 60 mol %, and is preferably 80 mol %, more preferably 90 mol %, and still more preferably 95 mol %. Furthermore, the degree of saponification of the vinyl alcohol polymer is preferably more than 96 mol %, and more preferably more than 97.0 mol %, more than 97.5 mol %, or more than 98.0 mol %. When the degree of saponification of the vinyl alcohol polymer is equal to or more than the lower limit or is more than the lower limit, the hygroscopicity decreases, and blocking between the layer A and the layer B under high humidity can be effectively inhibited, for example. The upper limit of the degree of saponification of the vinyl alcohol polymer may be 100 mol % or 99.9 mol %. The degree of saponification of the vinyl alcohol polymer is measured in accordance with JIS K 6726:1994.

The lower limit of a viscosity-average degree of polymerization of the vinyl alcohol polymer is preferably 200, more preferably 300, still more preferably 500, and even more preferably 800. The upper limit of the viscosity-average degree of polymerization is preferably 3,000, more preferably 2,500, and still more preferably 2,000. When the viscosity-average degree of polymerization of the vinyl alcohol polymer is equal to or more than the lower limit, the blocking resistance of the layer B is improved to more inhibit adhesion of the pigment to the layer B, the film-forming properties can be improved, and toughness can be imparted. When the viscosity-average degree of polymerization of the vinyl alcohol copolymer is equal to or less than the upper limit, molding processability can be imparted, and, for example, in a case in which an aqueous solution prepared from the copolymer is applied to a paper base material or the like, the vinyl alcohol copolymer can be applied with an appropriate viscosity.

The viscosity-average degree of polymerization of the vinyl alcohol polymer is measured in accordance with JIS K 6726:1994. Specifically, a limiting viscosity [η] (L/g) of the vinyl alcohol polymer is measured in water at 30° C., and the value of the limiting viscosity [η] is used to calculate a viscosity-average degree of polymerization P according to the following equation. It is to be noted that in a case in which the degree of saponification of the vinyl alcohol polymer is less than 99.5 mol %, the limiting viscosity [η] is measured after saponifying the polymer until the degree of saponification reaches 99.5 mol % or more.

$$P = {( [ η ] \times 1 {0}^{4} / 8.29 )}^{( 1 / 0.62 )}$$

The vinyl alcohol polymer may have a monomer unit derived from other monomer(s) aside from the vinyl alcohol unit and a vinyl ester unit. Examples of the other monomer(s) include: α-olefins such as ethylene, propylene, n-butene, and isobutylene; (meth)acrylic acids and salts thereof; (meth)acrylic acid esters; (meth)acrylamides; (meth)acrylamide derivatives such as N-methyl(meth)acrylamide, N-ethyl(meth)acrylamide, N,N-dimethyl(meth)acrylamide, diacetone (meth)acrylamide, (meth)acrylamide propane sulfonic acid and salts thereof, (meth)acrylamide propyl dimethyl amine and salts or quaternary salts thereof, and N-methylol(meth)acrylamide and derivatives thereof; vinyl ethers such as methyl vinyl ether, ethyl vinyl ether, n-propyl vinyl ether, i-propyl vinyl ether, n-butyl vinyl ether, i-butyl vinyl ether, t-butyl vinyl ether, dodecyl vinyl ether, and stearyl vinyl ether; nitriles such as acrylonitrile and methacrylonitrile; vinyl halides such as vinyl chloride and vinyl fluoride; vinylidene halides such as vinylidene chloride and vinylidene fluoride; allyl compounds such as allyl acetate and allyl chloride; unsaturated dicarboxylic acids such as maleic acid, itaconic acid, and fumaric acid and salts or esters thereof; vinylsilyl compounds such as vinyltrimethoxysilane; isopropenyl acetate; and the like.

The other monomer(s) that the vinyl alcohol polymer may have may be an α-olefin and may be ethylene. In the case in which the vinyl alcohol polymer has an α-olefin unit, the lower limit of a content percentage of the α-olefin unit with respect to total monomer units in the vinyl alcohol polymer may be 0.1 mol %, or may be 0.5 mol %, 1 mol %, 2 mol %, 3 mol %, or 4 mol %. On the other hand, the upper limit of the content percentage may be 20 mol %, or may be 15 mol %, 12 mol %, 10 mol %, 5 mol %, or 3 mol %. It is to be noted that the content percentage of the α-olefin unit with respect to the total monomer units is also referred to as a degree of α-olefin modification. For example, a content percentage of an ethylene unit with respect to the total monomer units is also referred to as a degree of ethylene modification.

A total content percentage of the vinyl alcohol unit and the vinyl ester unit with respect to total monomer units in the vinyl alcohol polymer is preferably 80 mol % or more, and more preferably 90 mol % or more, and may be 95 mol % or more, 98 mol % or more, 99 mol % or more, or 100 mol %. A total content percentage of the vinyl alcohol unit, the vinyl ester unit, and the α-olefin unit being optional, with respect to total monomer units in the vinyl alcohol polymer is preferably 95 mol % or more, and more preferably 99 mol % or more, and may be 100 mol %.

The lower limit of a content of the polymer (b) with respect to 100 parts by mass of the polymer (a) is 1 part by mass, preferably 5 parts by mass, more preferably 10 parts by mass, and still more preferably 20 parts by mass, and may be 30 parts by mass. Due to the content of the polymer (b) with respect to the polymer (a) being equal to or more than the lower limit, adhesion of the pigment to the layer B is inhibited, and as a result, favorable barrier properties are exhibited. The upper limit of the content of the polymer (b) with respect to 100 parts by mass of the polymer (a) is 50 parts by mass, and may be 45 parts by mass, 40 parts by mass, 35 parts by mass, or 30 parts by mass. Due to the content of the polymer (b) with respect to the polymer (a) being equal to or less than the upper limit, the barrier properties (for example, the water vapor barrier property) and the like can be improved.

The lower limit of a content of the polymer (b) in the layer B is preferably 1% by mass, more preferably 5% by mass, still more preferably 8% by mass, even more preferably 10% by mass, and further more preferably 12% by mass, and may be 15% by mass or 20% by mass. When the content of the polymer (b) in the layer B is equal to or more than the lower limit, adhesion of the pigment to the layer B is more inhibited, and as a result, the barrier properties can also be improved. On the other hand, the upper limit of the content is preferably 33% by mass, and more preferably 30% by mass, and may be 25% by mass or 20% by mass. When the content of the polymer (b) in the layer B is equal to or less than the upper limit, the barrier properties (for example, the water vapor barrier property) and the like can be improved.

The lower limit of a total content of the polymer (a) and the polymer (b) in the layer B is preferably 20% by mass, more preferably 40% by mass, still more preferably 60% by mass, and may be further preferably 80% by mass, 90% by mass, 95% by mass, 98% by mass, or 99% by mass. When the total content of the polymer (a) and the polymer (b) in the layer B is equal to or more than the lower limit, the advantages of using the polymer (a) and the polymer (b) in the layer B are particularly effectively exhibited, and the bending resistance and the barrier properties tend to be superior. The upper limit of the total content of the polymer (a) and the polymer (b) in the layer B may be 100% by mass, 99.9% by mass, or 99% by mass.

The layer B may further contain other component(s) aside from the polymer (a) and the polymer (b). The other component is exemplified by a polymer other than the polymer (a) and the polymer (b), a layered inorganic compound, a surfactant, a wetting agent, an oil-repellent agent, a defoaming agent, a dye, a thickening agent, and the like. The surfactant may be an emulsifier.

For example, in the case in which the layer B contains the layered inorganic compound, the barrier properties and the like of the multilayer structure may be more improved. Examples of the layered inorganic compound include micas, talc, montmorillonite, kaolinite, vermiculite, smectite, hectorite, taeniolite, acid clay, and the like. In the case in which the layer B contains the layered inorganic compound, a content of the layered inorganic compound in the layer B may be, for example, 1% by mass or more and 80% by mass or less. However, in a case in which the content of the layered inorganic compound in the layer B is large, the bending resistance may deteriorate, and the bending or the like may cause cracking of the layer B itself or cracking of another layer (for example, the barrier layer) that is in direct contact with the layer B. For such reasons, the upper limit of the content of the layered inorganic compound in the layer B may preferably be 50% by mass, 30% by mass, 10% by mass, 5% by mass, or 1% by mass. In one embodiment of the present invention, the layer B may not contain the layered inorganic compound.

The lower limit of a mass per unit area of each layer of the layer B is preferably 1 g/m², more preferably 2 g/m², still more preferably 3 g/m², and even more preferably 5 g/m². When the mass per unit area of each layer of the layer B is equal to or more than the lower limit, the barrier properties, the heat-sealing properties of the layer to serve as a heat-sealing layer, and the like can be improved. The upper limit of the mass per unit area of each layer of the layer B is preferably 100 g/m², more preferably 50 g/m², still more preferably 30 g/m², and even more preferably 20 g/m². When the mass per unit area of each layer of the layer B is equal to or less than the upper limit, reduction of the film thickness and the weight, etc., of the multilayer structure can be contemplated.

### Pre-Coat Layer

The pre-coat layer may be the layer B described above. Furthermore, in the case in which another layer such as the heat-sealing layer is the layer B, the pre-coat layer may not be the layer B. The pre-coat layer that is not the layer B may be, for example, a layer composed of the polymer (a) and other optional component. In the pre-coat layer that is not the layer B, the polymer (a) may be a principal component. Specific and suitable modes of the polymer (a) contained in the pre-coat layer that is not the layer B are similar to those of the polymer (a) contained in the layer B.

The lower limit of a mass per unit area of the pre-coat layer is preferably 1 g/m², more preferably 2 g/m², still more preferably 3 g/m², and even more preferably 5 g/m². When the mass per unit area of the pre-coat layer is equal to or more than the lower limit, the barrier properties and the like can be improved. The upper limit of the mass per unit area of the pre-coat layer is preferably 100 g/m², more preferably 50 g/m², still more preferably 30 g/m², and even more preferably 20 g/m². When the mass per unit area of the pre-coat layer is equal to or less than the upper limit, reduction of the film thickness and the weight, etc., of the multilayer structure can be contemplated.

### Barrier Layer

The barrier layer is typically a layer having a function of inhibiting the transmission of a gas or water vapor, and is preferably a layer having a function of inhibiting the transmission of an oxygen gas or water vapor. In other words, the barrier layer is preferably an oxygen barrier layer or a water vapor barrier layer. The barrier layer is exemplified by a metal film such as aluminum; an inorganic oxide film such as alumina or silicon oxide; a polymer film; and the like. The metal film and the inorganic oxide film may be a vapor-deposited film, a foil, or the like. The barrier layer may include one of these layers, or may include two or more different types of layers thereof. The polymer film preferably contains a water-soluble polymer, and more preferably contains a water-soluble polymer as a principal component.

The water-soluble polymer is exemplified by vinyl alcohol polymers, starches, cellulose derivatives, polyvinylpyrrolidone, urethane resins, polyacrylic acids and salts thereof, casein, polyethyleneimine, and the like. Of these, as the polymer used in the barrier layer, the vinyl alcohol polymers or the urethane resins are preferred, and the vinyl alcohol polymers are more preferred. Specific and suitable modes of the vinyl alcohol polymers that can be used in the barrier layer are similar to those of the vinyl alcohol polymers exemplified as the polymer (b) in the layer B.

The lower limit of a content of the water-soluble polymer in the polymer film is preferably 70% by mass, more preferably 80% by mass, and still more preferably 90% by mass. The upper limit of the content may be 100% by mass.

The polymer film may further contain other component(s) aside from the water-soluble polymer. The other component is exemplified by a polymer other than the water-soluble polymer, a layered inorganic compound, a dispersant, a surfactant, a defoaming agent, a dye, a thickening agent, and the like.

The lower limit of a mass per unit area of the barrier layer is preferably 0.3 g/m², more preferably 0.5 g/m², and still more preferably 1 g/m². When the mass per unit area of the barrier layer is equal to or more than the lower limit, the barrier properties can be improved, for example. The upper limit of the mass per unit area of the barrier layer is preferably 20 g/m², more preferably 10 g/m², and still more preferably 5 g/m², and may be even more preferably 3 g/m². When the mass per unit area of the barrier layer is equal to or less than the upper limit, it is possible to contemplate reduction of the thickness of the multilayer structure, and the like.

### Heat-Sealing Layer

The heat-sealing layer may be the layer B described above. It is to be noted that in the case in which the heat-sealing layer is a layer containing a vinyl alcohol polymer as the polymer (b), there is an additional advantage such as inhibition of cracking of the heat-sealing layer. It is believed that this is due to, for example, an increase in affinity between the barrier layer containing the water-soluble polymer and the heat-sealing layer, leading to less likelihood of, for example, repelling of the coating liquid during coating for providing the heat-sealing layer. In the case in which cracking of the heat-sealing layer is inhibited, the heat-sealing properties, the barrier properties, etc. are more improved. Furthermore, upon recycling of the multilayer structure, separation of the paper base material and the resin layer may be conducted. In the case in which the heat-sealing layer is peeled off from the multilayer structure, when there are few cracks of the heat-sealing layer, the heat-sealing layer can be easily peeled off, leading also to advantages such as an improvement in the recyclability.

The heat-sealing layer may not be the layer B in the case in which another layer such as the pre-coat layer is the layer B. The heat-sealing layer that is not the layer B may be, for example, a layer composed of the polymer (a) and other optional component. In the heat-sealing layer that is not the layer B, the polymer (a) may be a principal component. Specific and suitable modes of the polymer (a) contained in the heat-sealing layer that is not the layer B are similar to those of the polymer (a) contained in the layer B.

The lower limit of a mass per unit area of the heat-sealing layer is preferably 1 g/m², more preferably 2 g/m², still more preferably 3 g/m², and even more preferably 5 g/m². When the mass per unit area of the heat-sealing layer is equal to or more than the lower limit, the heat-sealing properties, the barrier properties, etc. can be improved. The upper limit of the mass per unit area of the heat-sealing layer is preferably 100 g/m², more preferably 50 g/m², still more preferably 30 g/m², and even more preferably 20 g/m². When the mass per unit area of the heat-sealing layer is equal to or less than the upper limit, reduction of the film thickness and the weight, etc., of the multilayer structure can be contemplated.

### Applications and the Like

The multilayer structure according to one embodiment of the present invention can be suitably used as a packaging material and the like.

The shape, size, etc. of the multilayer structure according to one embodiment of the present invention are not particularly limited. The multilayer structure may be in the form of a sheet, or may be formed into a predetermined shape. The multilayer structure may be in the form of a long sheet. For example, the lower limit of a length of the multilayer structure may be, for example, 5 m, 10 m, 50 m, or 100 m. The upper limit of the length may be, for example, 1,000,000 m or 100,000 m. The lower limit of a width of the multilayer structure may be, for example, 30 cm or 50 cm. The upper limit of the width may be, for example, 10 m or 5 m. In general, the longer the multilayer structure, the more likely its surfaces to be in contact in its rolled state are to adhere to each other, and when the multilayer structure is rolled with the pigment layer and the resin layer being in contact, the more likely the pigment is to adhere to the resin layer. Therefore, in the case in which the present invention is applied to such a long multilayer structure, advantages that adhesion of the pigment to the resin layer is inhibited and that favorable barrier properties are provided are particularly effectively obtained.

In the case in which the multilayer structure includes the heat-sealing layer(s), the multilayer structure can also be used in a state in which the multilayer structure is formed into a predetermined shape (for example, a bag shape) by heat-sealing the heat-sealing layer(s) together. The heat-sealing method is not particularly limited and may be a well-known method; for example, the heat sealing may be performed using a heat plate type heat sealer, an impulse sealer, an ultrasonic sealer, a friction heat sealer, a dielectric heat sealer, or the like.

### Method for Producing Multilayer Structure

A method for producing the multilayer structure according to one embodiment of the present invention is not particularly limited, and it can be produced, for example, by providing each layer on a paper base material by coating. Alternatively, a commercially available coated paper including the layer A provided on one face side of the paper base material may be purchased and used. The multilayer structure can be also produced by providing the layer B and the like on such coated paper. As an example, a multilayer structure 10 in FIG. 1 can be produced by the following procedure. With respect to coated paper including a layer A 11 and a paper base material 12, a pre-coat layer-forming coating liquid is applied on a face of the coated paper that exposes the paper base material 12, and the liquid is dried to provide a pre-coat layer 13. Next, a barrier layer-forming coating liquid is applied on a surface of the pre-coat layer 13, and the liquid is dried to provide a barrier layer 14. Next, a heat-sealing layer-forming coating liquid is applied on a surface of the barrier layer 14, and the liquid is dried to provide a heat-sealing layer 15. After each layer is provided, there may be a step of rolling the unfinished or finished long multilayer structure into a roll. Alternatively, the drying does not necessarily need to be performed after each applying of each coating liquid, and a simultaneous multilayer coating method may be employed.

Each coating liquid may be applied by a conventionally well-known method. For example, the applying may be performed using a blade coater, a bar coater, an air knife coater, a slit die coater, a gravure coater, a micro gravure coater, a gate roll coater, a curtain coater, a flexo coater, a comma coater, or the like.

A method for drying each coating liquid which has been applied is not particularly limited, and for example, a hot-air dryer, an infrared dryer, a gas burner, a heat plate, or the like may be used.

A solvent or a dispersion medium of the coating liquid for forming each layer is not particularly limited; water or an organic solvent (ethanol, isopropyl alcohol, methyl ethyl ketone, toluene, or the like) may be used, and water is preferred.

A solid content (solid content concentration) in the coating liquid for forming each layer is not particularly limited and may be, for example, 3% by mass or more and 70% by mass or less, may be 5% by mass or more and 60% by mass or less, or may be 10% by mass or more and 50% by mass or less.

### Rolled Structure

A rolled structure according to one embodiment of the present invention is a rolled structure obtained by rolling the multilayer structure according to one embodiment of the present invention, and in which the layer A and the layer B are in direct contact. An unfinished or finished long multilayer structure may be stored in a rolled state, for example. For example, in the case in which the multilayer structure 10 illustrated in FIG. 1 is rolled into a rolled structure, the layer A 11, which is one outermost layer, and the heat-sealing layer 15, which is the other outermost layer, are in direct contact. In the case in which the heat-sealing layer 15 is the layer B, the layer A and the layer B are to be in direct contact. Furthermore, in the case in which the multilayer structure including the layer A 11, the paper base material 12, and the pre-coat layer 13 in production process of the multilayer structure illustrated in FIG. 1 is rolled into a rolled structure, the layer A 11, which is one outermost layer, and the pre-coat layer 13, which is the other outermost layer, are in direct contact. In the case in which the pre-coat layer 13 is the layer B, the layer A and the layer B are to be in direct contact.

In the rolled structure according to one embodiment of the present invention, although the layer A, which is a pigment layer, and the layer B, which is a resin layer, are in direct contact, adhesion of the pigment to the resin layer (i.e., the layer B) is inhibited, and the multilayer structure has favorable barrier properties. Therefore, by employing the rolled structure, it is possible to, for example, efficiently produce and store the multilayer structure.

### Packaging Material

A packaging material according to one embodiment of the present invention may include the multilayer structure according to one embodiment of the present invention or may consist of the multilayer structure according to one embodiment of the present invention.

The packaging material has a favorable appearance because adhesion of the pigment to the resin layer is inhibited, and the packaging material also has favorable barrier properties. The packaging material is typically used such that the layer A side is on the outside with respect to the paper base material. The packaging material may be formed into a predetermined shape by heat sealing or the like. The packaging material is suitably used, for example, as packaging materials for foods, agrochemicals, chemicals, cosmetics, medical products, electronic components, clothing items, etc.

### EXAMPLES

Hereinafter, the present invention is more specifically described by way of Examples, but the present invention is not in any way limited to the Examples.

### Method for Measuring Glass Transition Temperature (Tg)

The glass transition temperature of the polymers was measured by the following method.

About 3 mg of a measurement sample was packed in a sample pan, and the glass transition point and the melting point were measured using a DSC Q2000 apparatus (manufactured by TA Instruments, Inc.). The temperature of the sample was increased from 30° C. to 200° C., then decreased to −90° C. and maintained for 5 min, and then increased to 200° C. Both the increase and decrease in temperature were conducted at 10° C./min.

### Production Example 1: Production of PVA-1

Into a reaction tank equipped with a stirrer, a nitrogen introduction port, and an initiator addition port, 1,050 g of vinyl acetate and 1,950 g of methanol were charged, and after the temperature was elevated to 60° C., the inside of the system was replaced with nitrogen by nitrogen bubbling for 30 min. After the temperature in the reaction tank was adjusted to 60° C., 1.6 g of azobisisobutyronitrile (AIBN) was charged as a polymerization initiator to start polymerization. Three hours later when the polymerization conversion reached 50%, cooling was performed to stop the polymerization. Unreacted vinyl acetate monomers were removed, and methanol was added to give a polyvinyl acetate (PVAc) solution in methanol (concentration: 30% by mass). To 400 g of the PVAc solution in methanol (PVAc in the solution: 120 g), 55.8 g of a 10% NaOH solution in methanol (molar ratio [MR] of the amount of NaOH to the vinyl acetate unit in the PVAc: 0.10) was added, and saponification was performed at 40° C. After the addition of the NaOH solution in methanol, resulting gelated matter was ground with a grinder and subjected to a saponification reaction for 1 hr. in total. Thereafter, 1,000 g of methyl acetate was added to neutralize the remaining alkali. A phenolphthalein indicator was used to confirm that the neutralization had been completed, 1,000 g of methanol was then added to a white solid obtained by filtration, and the resulting mixture was left to stand at room temperature for 3 hrs, and then washed. After the washing operation was repeated three times, a solid obtained by centrifugal deliquoring was left to stand and dried in a dryer at 70° C. for 2 days to give a vinyl alcohol polymer (PVA-1).

### Production Example 2: Production of PVA-2

Into a 5 L-pressure reaction tank equipped with a stirrer, a nitrogen introduction port, an ethylene introduction port, and an initiator addition port, 2,550 g of vinyl acetate and 450 g of methanol were charged, and after the temperature was elevated to 60° C., the inside of the system was replaced with nitrogen by nitrogen bubbling for 30 min. Next, ethylene was introduced such that the reaction tank pressure was 2.9 kg/cm². After the temperature in the reaction tank was adjusted to 60° C., 1.0 g of AIBN was charged as a polymerization initiator to start polymerization. During the polymerization, ethylene was introduced to maintain the reaction tank pressure at 2.9 kg/cm², and the polymerization temperature was maintained at 60° C. Three hours later when the polymerization conversion reached 20%, cooling was performed to stop the polymerization. After the reaction tank was opened to release ethylene, bubbling with a nitrogen gas was further performed. Next, unreacted vinyl acetate monomers were removed under reduced pressure, and methanol was added to give an ethylene-vinyl acetate copolymer solution in methanol (concentration: 20% by mass). To 400 g of the ethylene-vinyl acetate copolymer solution in methanol (ethylene-vinyl acetate copolymer in the solution: 80 g), 14.9 g of a 10% NaOH solution in methanol (molar ratio [MR] of the amount of NaOH to the vinyl acetate unit in the ethylene-vinyl acetate copolymer: 0.04) was added, and saponification was performed at 40° C. After the addition of the NaOH solution in methanol, the resulting gelated matter was ground with a grinder, and a saponification reaction was performed for 1 hr. in total. Thereafter, 1,000 g of methyl acetate was added to neutralize the remaining alkali. A phenolphthalein indicator was used to confirm that the neutralization had been completed, 1,000 g of methanol was then added to a white solid obtained by filtration, and the resulting mixture was left to stand at room temperature for 3 hrs, and then washed. After the washing operation was repeated three times, a solid obtained by centrifugal deliquoring was left to stand in a dryer at 70° C. for 2 days to give an ethylene-modified vinyl alcohol polymer (PVA-2).

### Production Examples 3 to 4: Production of PVA-3 to PVA-4

Each of ethylene-modified vinyl alcohol polymers (PVA-3 to PVA-4) was produced by a method similar to that of Production Example 2, except that the polymerization conditions and the saponification conditions were as shown in Table 1.

The viscosity-average degree of polymerization, the degree of saponification, the degree of ethylene modification (ethylene unit content), and the glass transition temperature (Tg) of each of the obtained PVA-1 to PVA-4 were measured. The measurement results are shown in Table 1.

TABLE 1

| | Polymerization conditions | | | | | | |
|---|---|---|---|---|---|---|---|
| | | | | | charged | | |
| | polymer- | | | polymer- | polymer- | polymer- | |
| | ization | | | ization | ization | ization | polymer- |
| | temper- | vinyl | | ethylene | initiator | time | ization |
| | ature | acetate | methanol | pressure | amount | period | conversion |
| PVA | ° C. | G | g | kg/cm² | g | h | % |
| PVA-1 | 60 | 1050 | 1950 | — | 1.6 | 3 | 50 |
| PVA-2 | 60 | 2550 | 450 | 2.9 | 1.0 | 3 | 20 |
| PVA-3 | 60 | 2640 | 360 | 7.3 | 0.8 | 3 | 20 |
| PVA-4 | 60 | 2550 | 450 | 3.5 | 1.0 | 3 | 20 |

| | | | | Analyses results | | | |
|---|---|---|---|---|---|---|---|
| | Saponification conditions | | | viscosity- | | | |
| | | NaOH | saponifi- | average | | ethylene | |
| | PVAc | addition | cation | degree of | degree of | modifi- | |
| | Concen- | amount | temper- | polymer- | saponifi- | cation | |
| | tration | molar | ature | ization | cation | degree | Tg |
| PVA | % | ratio | ° C. | — | mol % | mol % | ° C. |
| PVA-1 | 30 | 0.10 | 40 | 400 | 99.3 | 0 | 75 |
| PVA-2 | 20 | 0.04 | 40 | 1700 | 98.4 | 2 | 63 |
| PVA-3 | 20 | 0.04 | 40 | 2000 | 98.2 | 6 | 50 |
| PVA-4 | 20 | 0.01 | 40 | 1700 | 93.0 | 3 | 55 |

### Evaluation of Blocking Resistance

A coating liquid containing, as solid contents, styrene polymer-1 (a styrene-butadiene copolymer having a Tg of 3° C.) as the polymer (a) in an amount of 90% by mass and PVA-1 as the polymer (b) in an amount of 10% by mass was prepared. Furthermore, clay-coated paper (“Bladepak” manufactured by Twin Rivers Paper Company) including a clay-coated layer, as the layer A, provided on one face of a paper base material was provided. The above coating liquid was applied in a coating amount of 10 g/m² in dry mass, on a face of the clay-coated paper that exposed the paper base material, and the coating liquid was dried to provide the layer B, whereby a multilayer structure was obtained. The clay-coated face (the layer A) and a surface of the layer B were placed to face each other, and a pressure of 1 MPa was applied, and then the blocking resistance was evaluated in accordance with the following criteria. The results are shown in Table 2.
A: layers easily peeled off
B: layers adhered to some extent but peeled off
C: layers involved some difficulty in peeling off
D: peeling off layers failed, accompanied by tearing of the paper base material

### Examples 2 to 8 and Comparative Examples 1 and 2

Each multilayer structure was obtained similarly to Example 1, except that the type and the content of each polymer used as a solid content in each coating liquid were as shown in Table 2, and the blocking resistance of each multilayer structure was evaluated. The results are shown in Table 2. It is to be noted that the polymers (a) shown in Table 2 and Table 3 described later are as described below, and were each a commercial product.
Styrene polymer-1: styrene-butadiene copolymer having a Tg of 3° C.
Modified olefin polymer-1: carboxylic acid-modified polyethylene having a Tg of −23° C.
Modified olefin polymer-2: carboxylic acid-modified polyethylene having a Tg of −46° C.

TABLE 2

| | Polymer (a) | | | Polymer (b) | | | | Evaluation |
|---|---|---|---|---|---|---|---|---|
| | | | content | | | content | | blocking |
| | type | Tg | % by | type | Tg | % by | parts by | resistance |
| | — | ° C. | mass | — | ° C. | mass | mass*¹ | — |
| Example 1 | styrene polymer-1 | 3 | 90 | PVA-1 | 75 | 10 | 11.1 | B |
| Example 2 | modified olefin polymer-1 | −23 | 70 | PVA-2 | 63 | 30 | 42.9 | B |
| Example 3 | styrene polymer-1 | 3 | 90 | PVA-2 | 63 | 10 | 11.1 | B |
| Example 4 | styrene polymer-1 | 3 | 80 | PVA-2 | 63 | 20 | 25.0 | A |
| Example 5 | styrene polymer-1 | 3 | 70 | PVA-2 | 63 | 30 | 42.9 | A |
| Example 6 | styrene polymer-1 | 3 | 70 | PVA-3 | 50 | 30 | 42.9 | B |
| Example 7 | modified olefin polymer-2 | −46 | 80 | PVA-4 | 55 | 20 | 25.0 | C |
| Example 8 | modified olefin polymer-2 | −46 | 80 | PVA-1 | 75 | 20 | 25.0 | B |
| Comparative | modified olefin polymer-2 | −46 | 100 | — | — | — | — | D |
| Example 1 | | | | | | | | |
| Comparative | styrene polymer-1 | 3 | 100 | — | — | — | — | D |
| Example 2 | | | | | | | | |

*¹parts by mass with respect to 100 parts by mass of the polymer (a)

### Example 9

Clay-coated paper (“Bladepak” manufactured by Twin Rivers Paper Company) including a clay-coated layer, as the layer A, provided on one face of a paper base material was provided.

A pre-coat layer-forming coating liquid containing, as solid contents, the styrene polymer-1 as the polymer (a) in an amount of 90% by mass and the PVA-1 as the polymer (b) in an amount of 10% by mass was prepared. The pre-coat layer-forming coating liquid was applied in a coating amount of 10 g/m² in dry mass, on a face of the clay-coated paper that exposed the paper base material using a gravure coater, and the coating liquid was dried to provide a pre-coat layer as the layer B. The resulting multilayer structure in production process (layer A/paper base material/pre-coat layer) was rolled into a rolled structure. Thereafter, the multilayer structure was pulled out from the rolled structure, and a surface of the pre-coat layer was observed with an SEM (scanning electron microscope). As a result, pigment adhesion was not confirmed.

A barrier layer-forming coating liquid containing only PVA-1 as a solid content was prepared. The barrier layer-forming coating liquid was applied in a coating amount of 2 g/m² in dry mass, on a surface of the pre-coat layer using a gravure coater, and the coating liquid was dried to provide a barrier layer. The resulting multilayer structure in production process (layer A/paper base material/pre-coat layer/barrier layer) was rolled into a rolled structure, and then the multilayer structure was pulled out from the rolled structure.

A heat-sealing layer-forming coating liquid containing, as solid contents, the styrene polymer-1 as the polymer (a) in an amount of 90% by mass and the PVA-1 as the polymer (b) in an amount of 10% by mass was prepared. The heat-sealing layer-forming coating liquid was applied in a coating amount of 10 g/m² in dry mass, on a surface of the barrier layer using a gravure coater, and the coating liquid was dried to provide a heat-sealing layer as the layer B. The resulting multilayer structure (layer A/paper base material/pre-coat layer/barrier layer/heat-sealing layer) was rolled into a rolled structure. Thereafter, the multilayer structure was pulled out from the rolled structure, and a surface of the heat-sealing layer was observed with an SEM (scanning electron microscope). As a result, pigment adhesion was not confirmed.

On the obtained multilayer structure of Example 9 (layer A/paper base material/pre-coat layer/barrier layer/heat-sealing layer), the moisture permeability measured under conditions involving 23° C. and 85% RH was 58 cc/(m²·day). It is to be noted that the moisture permeability was measured in accordance with the dish method described in JIS Z 2080:1976, except that the temperature and the humidity of the above conditions were employed.

### Comparative Examples 3 and 4

Each of multilayer structures of Comparative Examples 3 and 4 was obtained similarly to Example 9, except that the type and the content of each polymer used as a solid content in the pre-coat layer-forming coating liquid and the heat-sealing layer-forming coating liquid were as shown in Table 3.

Similarly to Example 9, a surface of the pre-coat layer in each multilayer structure in production process was observed, a surface of the heat-sealing layer in each obtained multilayer structure was observed, and moisture permeability of each obtained multilayer structure was measured. The results are shown in Table 3.

It is to be noted that appearance evaluations based on the surface observation of the pre-coat layer and the heat-sealing layer were based on the following criteria which also apply to Example 9.
A: No pigment adhesion observed
B: Pigment adhesion observed, accompanied by roughness of the surface

TABLE 3

| | | | | | | | | Evaluation | | |
|---|---|---|---|---|---|---|---|---|---|---|
| | Polymer (a) | | | Polymer (b) | | | | | heat-sealing | |
| | | | content | | | content | | pre-coat | layer | moisture |
| | type | Tg | % by | type | Tg | % by | parts by | appearance | appearance | permeability |
| | — | ° C. | mass | — | ° C. | mass | mass*¹ | — | — | cc/(m² · day) |
| Example 9 | styrene polymer-1 | 3 | 90 | PVA-1 | 75 | 10 | 11.1 | A | A | 58 |
| Comparative | styrene polymer-1 | 3 | 100 | — | — | — | — | B | B | 103 |
| Example 3 | | | | | | | | | | |
| Comparative | styrene polymer-1 | 3 | 10 | PVA-1 | 75 | 90 | 900.0 | A | A | >150 |
| Example 4 | | | | | | | | | | |

*¹parts by mass with respect to 100 parts by mass of the polymer (a)

As shown in Table 3, pigment adhesion to the pre-coat layer and the heat-sealing layer was inhibited, and favorable barrier properties (a water vapor barrier property) were confirmed, on the multilayer structure of Example 9 containing the polymer (a) having a glass transition temperature of 25° C. or less and the polymer (b) having a glass transition temperature of 30° C. or more, and including the pre-coat layer and the heat-sealing layer that were formed so that the content of the polymer (b) with respect to 100 parts by mass of the polymer (a) was 1 part by mass or more and 50 parts by mass or less. The multilayer structure of Comparative Example 3 including the pre-coat layer and the heat-sealing layer that each did not contain the polymer (b) having a glass transition temperature of 30° C. or more resulted in pigment adhesion to the pre-coat layer and the heat-sealing layer, and insufficient gas barrier properties. The multilayer structure of Comparative Example 4 including the pre-coat layer and the heat-sealing layer that each excessively contained the polymer (b) having a glass transition temperature of 30° C. or more resulted in inhibited pigment adhesion to the pre-coat layer and the heat-sealing layer, but the gas barrier properties were insufficient.

The pre-coat layer-forming coating liquid and the heat-sealing layer-forming coating liquid used in Example 9 were the same as the coating liquids used in Example 1. Furthermore, the pre-coat layer-forming coating liquid and the heat-sealing layer-forming coating liquid used in Comparative Example 3 were the same as the coating liquids used in Comparative Example 2. As shown in Table 2, the layer B of each of Examples 1 to 8 containing the polymer (a) having a glass transition temperature of 25° C. or less and the polymer (b) having a glass transition temperature of 30° C. or more and formed so that a content of the polymer (b) with respect to 100 parts by mass of the polymer (a) was 1 part by mass or more and 50 parts by mass or less had favorable blocking resistance against the layer A (evaluated as A to C). On the other hand, the layer B of each of Comparative Examples 1 and 2 not containing a predetermined amount of the polymer (b) had poor blocking resistance against the layer A (evaluated as D). It can be presumed that there is a correlation between the favorable blocking resistance of the layer B against the layer A and inhibition of pigment adhesion to the layer B.

### INDUSTRIAL APPLICABILITY

The multilayer structure of the present invention can be suitably used as a packaging material.

### EXPLANATION OF REFERENCE SYMBOLS

10: multilayer structure
11: layer A
12: paper base material
13: pre-coat layer
14: barrier layer
15: heat-sealing layer

1. A multilayer structure comprising:
a paper base material;
a layer A laminated to one face side of the paper base material; and
a layer B laminated to another face side of the paper base material,
wherein
the layer A comprises a pigment;
the layer B comprises a polymer (a) having a glass transition temperature of 25° C. or less, and a polymer (b) having a glass transition temperature of 30° C. or more; and
a content of the polymer (b) with respect to 100 parts by mass of the polymer (a) is 1 part by mass or more and 50 parts by mass or less.

2. The multilayer structure according to claim 1, wherein the polymer (a) and the polymer (b) are each water-soluble or water-dispersible.

3. The multilayer structure according to claim 1, wherein a total content of the polymer (a) and the polymer (b) in the layer B is 20% by mass or more and 100% by mass or less.

4. The multilayer structure according to claim 1, wherein the polymer (b) is a vinyl alcohol polymer.

5. The multilayer structure according to claim 4, wherein the vinyl alcohol polymer has a degree of saponification of 80 mol % or more and 100 mol % or less.

6. The multilayer structure according to claim 4, wherein the vinyl alcohol polymer has a degree of saponification of more than 96 mol % and 100 mol % or less.

7. The multilayer structure according to claim 4, wherein the vinyl alcohol polymer has a viscosity-average degree of polymerization of 200 or more and 3,000 or less.

8. The multilayer structure according to claim 1, wherein the polymer (a) comprises at least one selected from the group consisting of a styrene polymer, a modified olefin polymer, and an ester polymer.

9. The multilayer structure according to claim 1, comprising the layer A, the paper base material, a pre-coat layer, a barrier layer, and a heat-sealing layer in this order, wherein the pre-coat layer is the layer B.

10. The multilayer structure according to claim 1, comprising the layer A, the paper base material, a pre-coat layer, a barrier layer, and a heat-sealing layer in this order,
wherein the heat-sealing layer is the layer B.

11. The multilayer structure according to claim 1, comprising the layer A, the paper base material, a pre-coat layer, a barrier layer, and a heat-sealing layer in this order,
wherein the pre-coat layer and the heat-sealing layer are the layer B.

12. The multilayer structure according to claim 9, wherein the barrier layer comprises a vinyl alcohol polymer.

13. A rolled structure formed by rolling the multilayer structure according to claim 1,
wherein the layer A and the layer B are in direct contact.

14. A packaging material comprising the multilayer structure according to claim 1.
